(19) United States
(12) Patent Application Publication
(10) Pub. No.: US 2006/0089982 A1
(43) Pub. Date: Apr. 27, 2006

(54) Method, system, and computer program product for capacity planning by function

(75) Inventors: John M. Abbott, Park City, UT (US); Eric B. Libow, Coral Springs, FL (US); Robert L. Orr, Raleigh, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/974,099

(22) Filed: Oct. 26, 2004

(51) Int. Cl. G06F 15/173

(52) U.S. Cl. 709/223

(57) ABSTRACT

The present invention provides a method, system, and computer program product for capacity planning by function. The method comprises: periodically collecting metrics for a plurality of components in a dynamic system; periodically determining dynamic system membership for a function provided by the dynamic system; providing at least one summation formula; and determining system wide metrics by function using the component metrics, the dynamic system membership for the function, and the at least one summation formula.

### BACKGROUND OF THE INVENTION

1. Field of the Invention

The present invention generally relates to data collection systems. More particularly, the present invention provides a method, system, and computer program product for capacity planning by function.

2. Related Art

Capacity planning involves balancing capacity with demand. Capacity is the amount of traffic or processing that a resource is capable of supporting; demand is the load that users or applications place upon that resource. Capacity planning is the process used to evaluate the current trends in resource usage and plan for growth and changes before problems occur. Capacity planning's benefits range from avoiding the inconvenience of running out of disk space to ensuring enough processing power to handle a global organization's computing workload.

Resource use metrics are generally collected and capacity planning projections are done on a server-by-server basis. In today's on-demand world (e.g., dynamic provisioning, server farms, etc.), however, these measurements and projections also should be done in dynamic groupings based on function, since understanding the performance of a business function outweighs the performance of an individual machine. Unfortunately, currently available methodologies fail to provide capacity planning by function.

### SUMMARY OF THE INVENTION

In general, the present invention provides a method, system, and computer program product for capacity planning by function.

A first aspect of the present invention is directed to a method for capacity planning by function, comprising: periodically collecting metrics for a plurality of components in a dynamic system; periodically determining dynamic system membership for a function provided by the dynamic system; providing at least one summation formula; and determining system wide metrics by function using the component metrics, the dynamic system membership for the function, and the at least one summation formula.

A second aspect of the present invention is directed to a system for capacity planning by function, comprising: a system for periodically collecting metrics for a plurality of components in a dynamic system; a system for periodically determining dynamic system membership for a function provided by the dynamic system; a system for providing at least one summation formula; and a system for determining system wide metrics by function using the component metrics, the dynamic system membership for the function, and the at least one summation formula.

A third aspect of the present invention is directed to a program product stored on a recordable medium for capacity planning by function, which when executed comprises: program code for periodically collecting metrics for a plurality of components in a dynamic system; program code for periodically determining dynamic system membership for a function provided by the dynamic system; program code for providing at least one summation formula; and program code for determining system wide metrics by function using the component metrics, the dynamic system membership for the function, and the at least one summation formula.

A fourth aspect of the present invention is directed to a method for deploying an application for capacity planning by function, comprising: providing a computer infrastructure being operable to: periodically collect metrics for a plurality of components in a dynamic system; periodically determine dynamic system membership for a function provided by the dynamic system; provide at least one summation formula; and determine system wide metrics by function using the component metrics, the dynamic system membership for the function, and the at least one summation formula.

A fifth aspect of the present invention is directed to computer software embodied in a propagated signal for capacity planning by function, the computer software comprising instructions to cause a computer system to perform the following functions: periodically collect metrics for a plurality of components in a dynamic system; periodically determine dynamic system membership for a function provided by the dynamic system; provide at least one summation formula; and determine system wide metrics by function using the component metrics, the dynamic system membership for the function, and the at least one summation formula.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram illustrating a method for capacity planning by function, in accordance with an embodiment of the present invention.

FIGS. 2-4 depict an illustrative system in accordance with an embodiment of the present invention.

FIG. 5 depicts a computer system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for capacity planning by function.

The present invention gathers relationship data on the same interval as performance metrics in order to correlate the data by function. Automatically correlating this data is important to being able to properly perform on-demand capacity planning.

The present invention provides the means and intelligence for the flexible correlation of individual component metric values into dynamically grouped metrics. To accomplish this, the attributes of the larger dynamic (e.g., on-demand) system (whether it is a server pool, clustered system, application components running on varied hosts, etc.) are themselves monitored and recorded at a rate similar to the collection/aggregation of individual component performance metrics.

In a typical data-warehousing environment, the components that make up a dynamic system are considered attributes or dimensions of the component. The dynamic system magnifies one of the classic data warehousing conundrums of dealing with slowly changing attributes, since the dynamic provisioning of resources, required by on-demand capacity management, causes rapid and frequent system changes. The present invention handles the changing attributes as additional metrics of the dynamic system.

Currently, component/measurement data warehouse schemas, such as Tivoli's implementation (as of Tivoli Data Warehouse v1.2, available from International Business Machines, Inc. of Armonk, N.Y.), have a two sided structure. The component side of the schema tracks individual components such as servers, applications, application components, and interfaces. Metric values are stored in attribute tables to describe nearly static information about these components. Component hierarchies may also be recorded to show nearly static relationships between components. The measurement side of the schema describes the individual measurements that are made against the components. A measurement fact table stores the measurement data along with the required link to the component being measured. The present invention provides a third specialized schema to hold the dynamic system attributes as if they were non-numeric metrics of the system. This system schema records the dynamic system membership, measured at, or near, the pace of the individual component metric measurements. Component instances are recorded in the component schema and dynamic system membership is contained in a membership table in the new system schema. The measurements made against the existing components of the dynamic system are recorded, by relationship, to the measurement schema, in the system schema.

To facilitate the calculation of numeric metric measurements against the dynamic system, several steps are taken. First, the dynamic system is recorded in the component structure as a component itself. Second, for all desired metrics, the appropriate “summation” formulas are identified/provided. These formulas provide the ability to determine appropriate system wide metrics from the metrics values collected for the system components supporting each function of interest. For example, one summation formula may be the standard deviation of the average of the metric values collected for the system components supporting a function. Other examples may include the average of all averaged values for a metric, the maximum of all maximum metric values, the minimum of all the minimum metric values, etc. Many other summation formulas are also possible. These calculations relate to, and are derived from, the types of metric values commonly stored in a data warehouse, including minimum, maximum, average, and/or total measured values, recorded in a given time interval. These system formulas, and their appropriateness towards individual metrics, are stored as part of the system schema and the relationship is formed to the measurement schema. Lastly, ETLs (extract, transform, and load scripts) consult the dynamic system summation formulas to populate the dynamic system measurements in the system schema.

In summary, the invention includes the following:

(1) The incremental extraction/determination of dynamic system membership;

(2) Data-warehouse schema enhancement to store the component, measurement, and attribute data for the dynamically provisioned system;

(3) Standard system summation formulas for desired metrics, and the ability to accommodate user defined system summation formulas; and

(4) ETLs to fill the new system schema, and provide the means for deriving system metrics from member metric measurements.

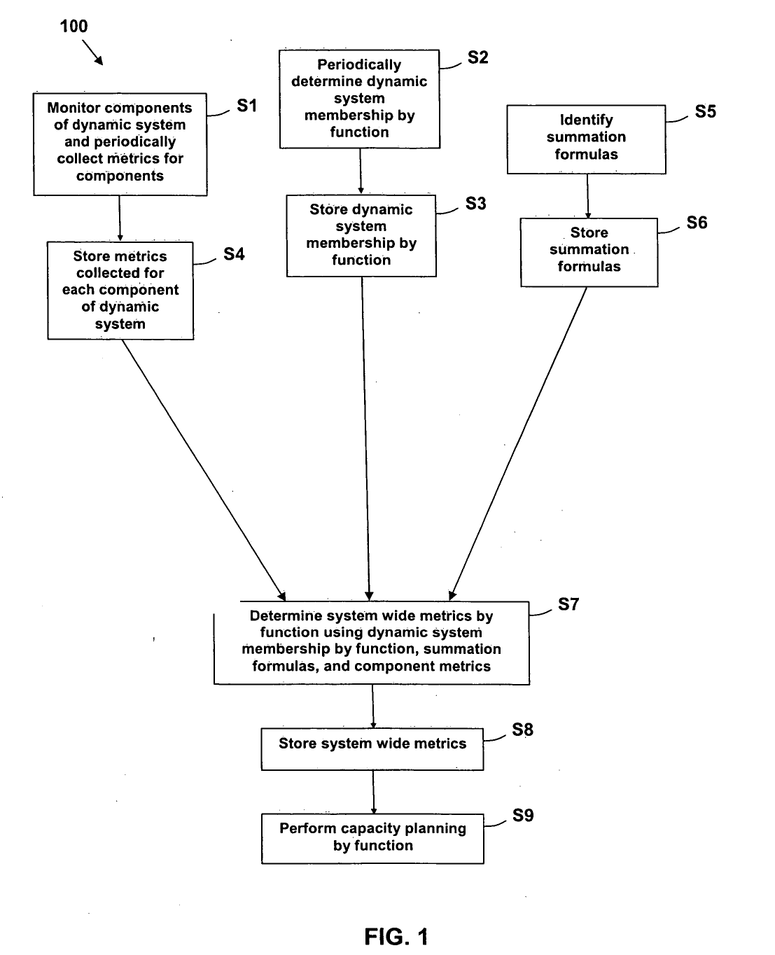

Referring to FIG. 1, there is provided a flow diagram 100 illustrating a method for capacity planning by function, in accordance with an embodiment of the present invention. In step S1, the components of the dynamic system are monitored and metric are periodically collected for each component. The monitoring/collection of component metrics can be carried out using any now known or later developed method. The specific metrics collected for each component are component/application specific and may vary from system to system. For example, in a dynamic system comprising a pool of servers, the metrics may comprise CPU usage, disk accesses, file system usage, server performance, etc. Many other metrics are also possible. The metrics for each component can be periodically collected according to a fixed/variable schedule. For example, the metrics can be periodically collected every 5 minutes, every hour, once a day, etc.

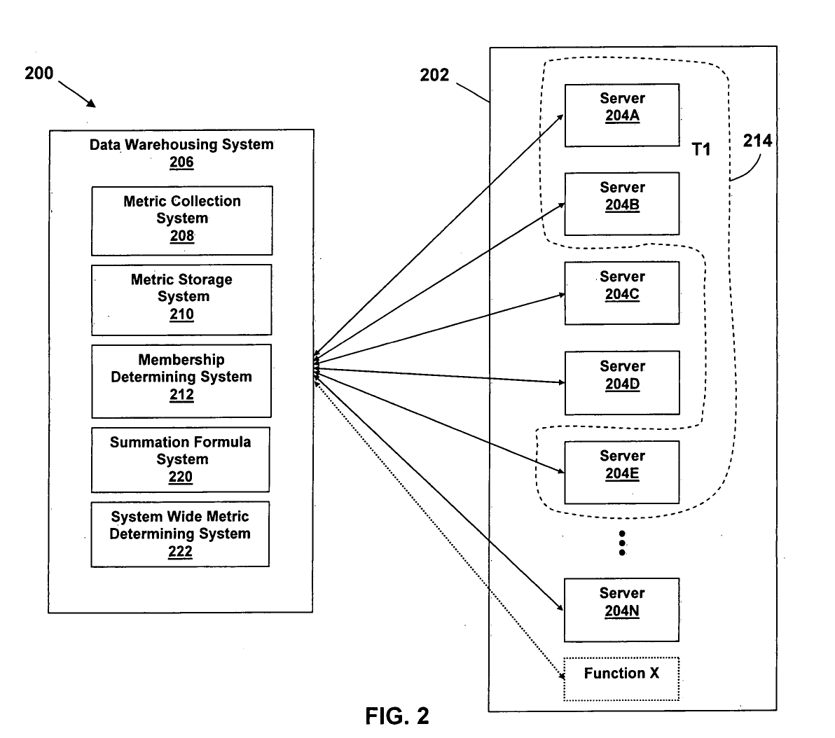

In step S2, dynamic system membership by function is periodically determined for at least one predetermined function provided by the dynamic system. The dynamic system membership is determined at, or near, the rate of the individual component metric measurements. For example, in a dynamic system comprising a pool of servers (server A, server B, server C, . . . , server N), dynamic system membership for the servers in the pool which support a given function X is periodically determined. This example is illustrated in greater detail with reference to FIGS. 2-4. In step S3, information regarding dynamic system membership by function is stored (e.g., in a membership table).

In FIGS. 2-4, there is depicted an illustrative system 200 comprising a server pool 202 including a plurality of servers 204 (server 204A, server 204B, server 204C, server 204D, server 204E, . . . , server 204N). System 200 further comprises a data warehousing system 206 including a metric collection system 208, a metric storage system 210, and a membership determining system 212. Data warehousing system 206 is connected to each server 204 in some manner (e.g., via a network). The membership determining system 212 can be provided as part of the data warehousing system 206 as shown in FIGS. 2-4, or may be provided as a separate system. Also included in the data warehousing system 206 is a summation formula system 220 for providing standard and/or user defined summation formulas.

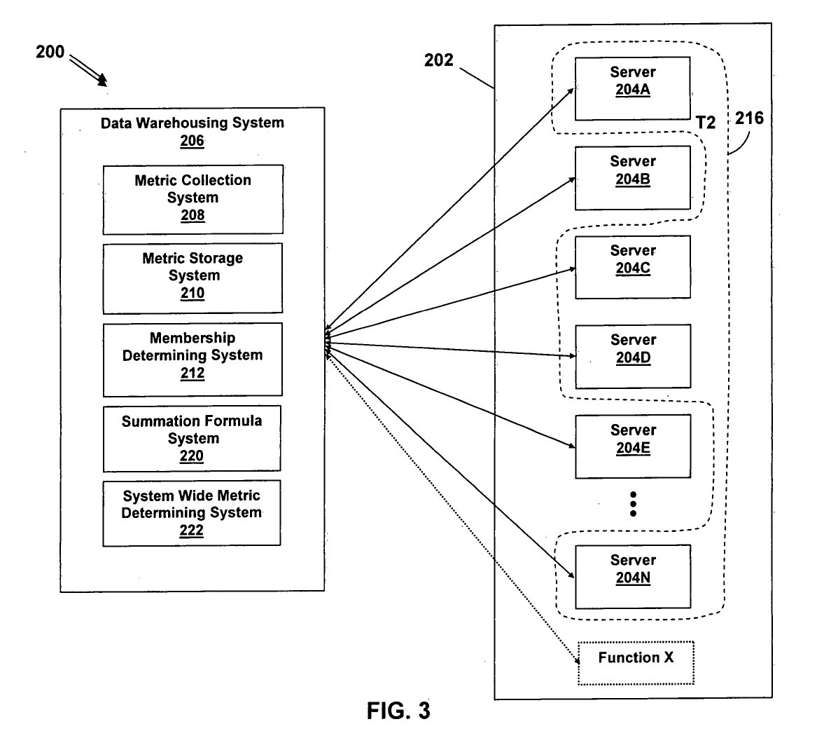

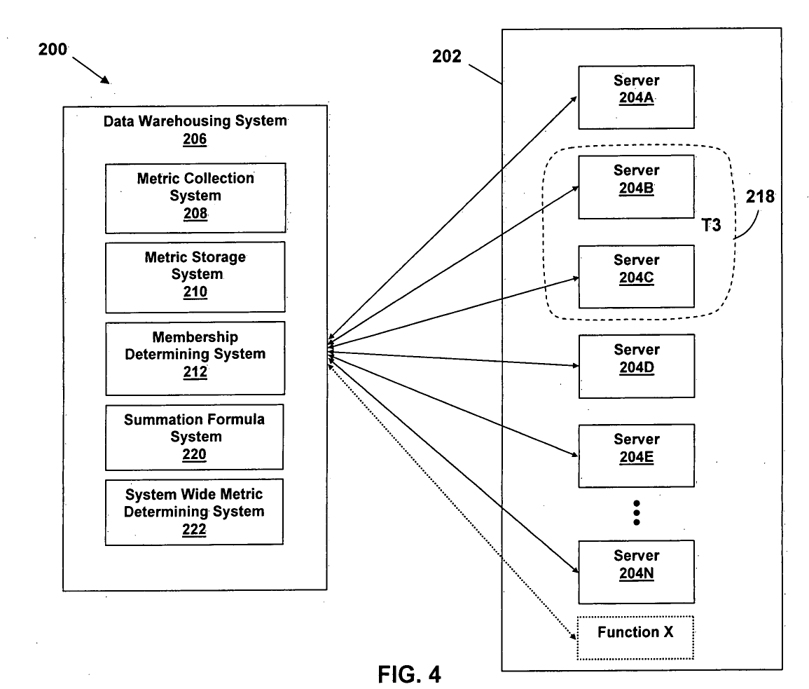

At a time T1, the membership determining system 212 determines that servers 204A, 204B, and 204E of the server pool 202 support function X. The dynamic system membership in server pool 202 for function X at time T1 is indicated by reference numeral 214 in FIG. 2. At a later time T2, the membership determining system 212 determines that servers 204A, 204C, 204D, and 204N of the server pool 202 now support function X. The dynamic system membership in server pool 202 for function X at time T2 is indicated by reference numeral 216 in FIG. 3 (i.e., as a component of server pool 202). Comparing FIGS. 2 and 3, it is apparent that the number of servers 204 serving function X has changed from T1→T2 (i.e., from 3 at T1 to 4 at T2). At a later time T3, the membership determining system 212 determines that servers 204B and 204C of the server pool 202 now support function X. The dynamic system membership in server pool 202 for function X at time T3 is indicated by reference numeral 218 in FIG. 4. Comparing FIGS. 3 and 4, it can be seen that the number of servers 204 serving function X has changed from T2→T3 (i.e., from 4 at T2 to 2 at T3). An illustrative membership table for function X at times T1, T2, and T3 is depicted in Table 1 below:

TABLE 1

| | |
|---|---|
| Function X (T1) | Server 204A, Sever 204B, Server 204E |
| Function X (T2) | Server 204A, Sever 204C, Server 204D, Server 204N |
| Function X (T3) | Server 204B, Sever 204C |

In accordance with the present invention, a function can comprise any type of task, process, etc., performed by one or more of the components of a system being monitored. For example, function X may comprise the “view item” function of an on-line auction system (e.g., users may request to view an item up for bid on an on-line auction site such as Ebay®). To this extent, assuming that the “view item” function is supported by the server pool 202 (FIGS. 2-4), when users select the button “view item” on a web page provided by the on-line auction site, the requests are handled by one or more of the servers 204 in server pool 202. Other practical examples of functions include the reservations function of a rental car company and the on-line banking application of a financial institution.

Referring back to the flow diagram 100 depicted in FIG. 1, in step S4, the metrics collected for each component of the dynamic system collected in step S1 are stored (e.g., in metric storage system 210, FIGS. 2-4). Table 2 below depicts illustrative sample values collected and stored for a metric A (e.g., CPU usage %) for each of the components (i.e., servers 204) in server pool 202 at times T1, T2, and T3. Also provided in Table 2 is a system wide metric by function corresponding to function X, which is also treated as a component of the server pool 202 by the present invention.

TABLE 2

| | Server | Server | Server | Server | Server | | Server | Function X |
|---|---|---|---|---|---|---|---|---|
| | 204A | 204B | 204C | 204D | 204E | . . . | 204N | (Avg) |
| Metric A (T1) | 100% | 52% | 15% | 98% | 75% | | 57% | 76% |
| Metric A (T2) | 84% | 100% | 100% | 95% | 81% | | 100% | 95% |
| Metric A (T3) | 5% | 9% | 22% | 11% | 20% | | 3% | 16% |

In step S5, one or more standard and/or user defined “summation” formulas are identified/provided for at least one desired metric. The summation formula(s) determined in step S5 are stored in step S6. The summation formulas provide the ability to form appropriate system wide metrics by function from the metric values collected for the system components supporting each function of interest. For example, one summation formula may comprise the average value of a metric determined for each of the components supporting a given function at a given time. Many other types of summation formulas are also possible, depending on the type of system being monitored, the functions provided by such systems, etc. In step S7, the system wide metrics by function are calculated using the dynamic system membership by function, summation formulas, and component metrics by a system wide metric determining system 222.

In Table 2, the summation formula used is the average of Metric A for each of the components supporting function X at a given time. At time T1, for example, the summation formula calculates a value of 76% for function X. That is, the average value of Metric A for the servers 204A, 204B, and 204E that support function X at T1 is 76%. Similarly, at times T2 and T3, the summation formula calculates values of 95% and 16%, respectfully, which indicate that the average value of Metric A for the servers 204A, 204C, 204D, and 204N that support function X at T2 is 95%, while the average value of Metric A for the servers 204B and 204C that support function X at time T3 is 16%. Similar data can be calculated for other metrics using the same/different summation formulas to provide a wide variety of information that can be used for capacity planning by function.

In step S8, the system wide metrics by function determined in step S7 are stored (e.g., in metric storage system 210, FIGS. 2-4). In step S9, the system wide metrics by function are analyzed and used for capacity planning by function. Advantageously, the system wide metrics by function determined in step S7 provide an additional dimension for use in capacity planning by function.

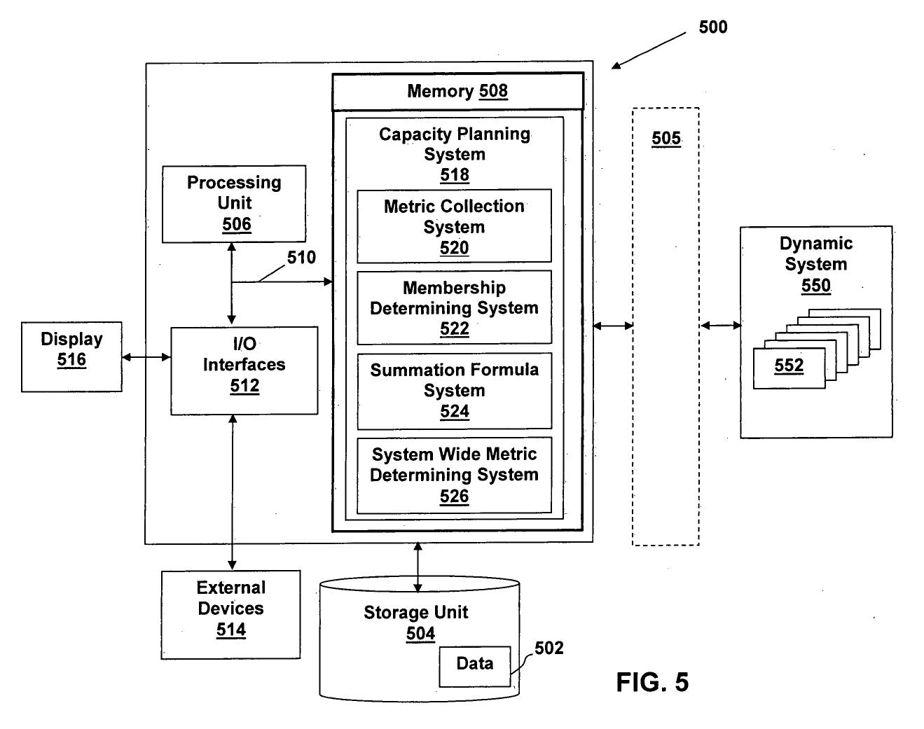

Referring now to FIG. 5, there is illustrated a computer system 500 for capacity planning by function in accordance with the present invention. Computer system 500 is intended to represent any type of computerized system capable of implementing the methods of the present invention. For example, computer system 500 may comprise a desktop computer, laptop computer, workstation, server, hand-held device, pager, etc.

Data 502 (e.g., component metrics, dynamic system membership by function, summation formulas, system wide metrics by function) used in the practice of the present invention can be stored locally to computer system 500, for example, in storage unit 504, and/or may be provided to computer system 500 over a network 505. Storage unit 504 can be any system capable of providing storage for data and information under the present invention. As such, storage unit 504 may reside at a single physical location, comprising one or more types of data storage, or may be distributed across a plurality of physical systems in various forms. In another embodiment, storage unit 504 may be distributed across, for example, a local area network (LAN), wide area network (WAN) or a storage area network (SAN) (not shown). Network 505 is intended to represent any type of network over which data can be transmitted. For example, network 505 can include the Internet, a wide area network (WAN), a local area network (LAN), a virtual private network (VPN), a WiFi network, a personal area network (PAN), or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer system 500 generally includes a processing unit 506, memory 508, bus 510, input/output (I/O) interfaces 512 and external devices/resources 514. Processing unit 506 may comprise a single processing unit, or may be distributed across one or more processing units in one or more locations, e.g., on a client and server. Memory 508 may comprise any known type of data storage and/or transmission media, including magnetic media, optical media, random access memory (RAM), read-only memory (ROM), etc. Moreover, similar to processing unit 506, memory 508 may reside at a single physical location, comprising one or more types of data storage, or be distributed across a plurality of physical systems in various forms.

I/O interfaces 512 may comprise any system for exchanging information to/from an external source. External devices/resources 514 may comprise any known type of external device, including speakers, a CRT, LED screen, handheld device, keyboard, mouse, voice recognition system, speech output system, printer, monitor/display (e.g., display 516), facsimile, pager, etc.

Bus 510 provides a communication link between each of the components in computer system 500, and likewise may comprise any known type of transmission link, including electrical, optical, wireless, etc. In addition, although not shown, other components, such as cache memory, communication systems, system software, etc., may be incorporated into computer system 500.

Shown in memory 508 is a capacity planning system 518, which may be provided as a computer program product. Capacity planning system 518 includes a metric collection system 520 for monitoring a plurality of components 552 of a dynamic (e.g., on demand) system 550 and for periodically collecting metrics for the plurality of the components 552, and a membership determining system 522 for periodically determining membership by function of the components 552 of the dynamic system 550. Also provided in memory 508 of capacity planning system 518 is a summation formula system 524 for providing standard and/or user defined summation formulas, and a system wide metric determining system 526 for determining system wide metrics by function using the dynamic system membership by function provided by the membership determining system 522, summation formulas provided by the summation formula system 524, and component metrics provided by the metric collection system 520.

It should be appreciated that the teachings of the present invention can be offered as a business method on a subscription or fee basis. For example, computer system 500 could be created, maintained, supported, and/or deployed by a service provider that offers the functions described herein for customers. That is, a service provider could be used to provide capacity planning by function, as described above.

It also should be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A method for capacity planning by function, comprising:
periodically collecting metrics for a plurality of components in a dynamic system;
periodically determining dynamic system membership for a function provided by the dynamic system;
providing at least one summation formula; and
determining system wide metrics by function using the component metrics, the dynamic system membership for the function, and the at least one summation formula.

2. The method of claim 1, wherein the step of periodically collecting metrics further comprises:
monitoring the components of the dynamic system.

3. The method of claim 1, wherein the dynamic system membership for the function is treated as a component of the dynamic system.

4. The method of claim 1, further comprising:
storing the component metrics, dynamic system membership, and system wide metrics by function.

5. The method of claim 1, further comprising:
periodically collecting the component metrics and periodically determining the dynamic system membership at similar rates.

6. A system for capacity planning by function, comprising:
a system for periodically collecting metrics for a plurality of components in a dynamic system;
a system for periodically determining dynamic system membership for a function provided by the dynamic system;
a system for providing at least one summation formula; and
a system for determining system wide metrics by function using the component metrics, the dynamic system membership for the function, and the at least one summation formula.

7. The system of claim 6, wherein the system for periodically collecting metrics further comprises:
a system for monitoring the components of the dynamic system.

8. The system of claim 6, wherein the dynamic system membership for the function comprises a component of the dynamic system.

9. The system of claim 6, further comprising:
a system for storing the component metrics, dynamic system membership, and system wide metrics by function.

10. The system of claim 6, wherein the component metrics and the dynamic system membership are collected and determined, respectively, at similar rates.

11. A program product stored on a recordable medium for capacity planning by function, which when executed comprises:
program code for periodically collecting metrics for a plurality of components in a dynamic system;
program code for periodically determining dynamic system membership for a function provided by the dynamic system;
program code for providing at least one summation formula; and
program code for determining system wide metrics by function using the component metrics, the dynamic system membership for the function, and the at least one summation formula.

12. The program product of claim 11, wherein the program code for periodically collecting metrics further comprises:
program code for monitoring the components of the dynamic system.

13. The program product of claim 11, wherein the dynamic system membership for the function is treated as a component of the dynamic system.

14. The program product of claim 11, further comprising:
program code for storing the component metrics, dynamic system membership, and system wide metrics by function.

15. The program product of claim 11, further comprising:
program code for periodically collecting the component metrics and periodically determining the dynamic system membership at similar rates.

16. A method for deploying an application for capacity planning by function, comprising:
providing a computer infrastructure being operable to:
periodically collect metrics for a plurality of components in a dynamic system;
periodically determine dynamic system membership for a function provided by the dynamic system;
provide at least one summation formula; and
determine system wide metrics by function using the component metrics, the dynamic system membership for the function, and the at least one summation formula.

17. Computer software embodied in a propagated signal for capacity planning by function, the computer software comprising instructions to cause a computer system to perform the following functions:
periodically collect metrics for a plurality of components in a dynamic system;
periodically determine dynamic system membership for a function provided by the dynamic system;
provide at least one summation formula; and
determine system wide metrics by function using the component metrics, the dynamic system membership for the function, and the at least one summation formula.
